(19) United States
(12) Patent Application Publication
(10) Pub. No.: US 2020/0062022 A1
(43) Pub. Date: Feb. 27, 2020

(54) WRITING INSTRUMENT HOLDER AND WRITING INSTRUMENT HOLDER SET

(71) Applicant: KOTOBUKI & CO., LTD., Kawagoe-shi (JP)

(72) Inventor: Takaaki NAKATA, Kawagoe-shi (JP)

(21) Appl. No.: 16/675,041

(22) Filed: Nov. 5, 2019

Related U.S. Application Data
(63) Continuation of application No. PCT/JP2017/021019, filed on Jun. 6, 2017.

(51) Int. Cl. B43K 23/10; B43K 23/02

(52) U.S. Cl. CPC B43K 23/10; B43K 23/02

(57) ABSTRACT

A writing instrument holder according to an aspect is a writing instrument holder that chucks a writing instrument, a width of a rear end part of which is larger than a width of a shaft thereof, the writing instrument holder including, a barrel that houses at least a part of the writing instrument, and a chuck that chucks the writing instrument, wherein the barrel has a front end opening, through which a front end part of the writing instrument can pass, and a rear end opening, through which a rear end part of the writing instrument can pass.

### CROSS-REFERENCE TO RELATED APPLICATION

This application is based upon and claims the benefit of priority under 35 USC 119 of PCT Application No. PCT/JP2017/021019 filed on Jun. 6, 2017, the entire disclosure of which, including the description, claims, drawings, and abstract, is incorporated herein by reference in its entirety.

### FIELD

This disclosure relates to a writing instrument holder and a writing instrument holder set which chuck a writing instrument.

### BACKGROUND

Conventionally, a rod-like object locking device and a writing instrument using the rod-like object locking device are known, the rod-like object locking device including a hollow holder to be gripped by a user, an opening formed at a tip of the hollow holder, a rod-like object, the tip of which is protruded from the opening, and an elastic ring which has an outer diameter that is larger than an inner diameter of the opening and which is provided on the rod-like object (for example, refer to Japanese Patent Application Laid-open No. H07-214973 (paragraphs 0004 and 0014)). According to the rod-like object locking device and the writing instrument using the rod-like object locking device, since backlash of the rod-like object does not occur and a soft touch can be attained during use, fatigue can be reduced even after a long period of use. In addition, the rod-like object can be prevented from detaching from the hollow holder, and replacing the rod-like object can be facilitated.

### DISCLOSURE

However, conventionally, it is difficult to chuck a writing instrument, a width of a rear end part of which is larger than a width of a shaft thereof, with a writing instrument holder and to use the chucked writing instrument. Therefore, there is a desire to provide a writing instrument holder capable of chucking a writing instrument, a width of a rear end part of which is larger than a width of a shaft thereof.

This disclosure provides a writing instrument holder and a writing instrument holder set capable of chucking a writing instrument, a width of a rear end part of which is larger than a width of a shaft thereof.

### SUMMARY

In an aspect of the present invention, a writing instrument holder chucking a writing instrument, a width of a rear end part of which is larger than a width of a shaft thereof, the writing instrument holder including, a barrel that houses at least apart of the writing instrument, and a chuck that chucks the writing instrument, wherein the barrel has a front end opening, through which a front end part of the writing instrument can pass, and a rear end opening, through which a rear end part of the writing instrument can pass.

In another aspect of the present invention, a writing instrument holder set in which a plurality of the writing instrument holders described above is combined, wherein a barrel of one writing instrument holder is configured so as to be shorter than a barrel of another writing instrument holder.

In one of the aspects of the present invention, a writing instrument holder and a writing instrument holder set capable of chucking a writing instrument, a width of a rear end part of which is larger than a width of a shaft thereof, can be provided.

### BRIEF DESCRIPTION OF DRAWINGS

FIG. 1 is a longitudinal sectional view illustrating, cut away along an axis thereof, a writing instrument holder according to an embodiment;

FIG. 2A is a side view illustrating a barrel of a writing instrument holder according to an embodiment;

FIG. 2B is a rear end surface diagram illustrating a barrel of a writing instrument holder according to an embodiment;

FIG. 3A is a side view illustrating a cap of a writing instrument holder according to an embodiment;

FIG. 3B is a rear end surface diagram illustrating a cap of a writing instrument holder according to an embodiment;

FIG. 4 is a longitudinal sectional view illustrating a state of attaching a cap of a writing instrument holder according to an embodiment to a rear end part of a barrel and using a writing lead for a writing instrument; and

FIG. 5 is a longitudinal sectional view illustrating a state of attaching a cap of a writing instrument holder according to an embodiment to a front end part of a barrel and protecting a writing lead for a writing instrument by housing the writing lead for a writing instrument inside the writing instrument holder.

### DESCRIPTION OF EMBODIMENT

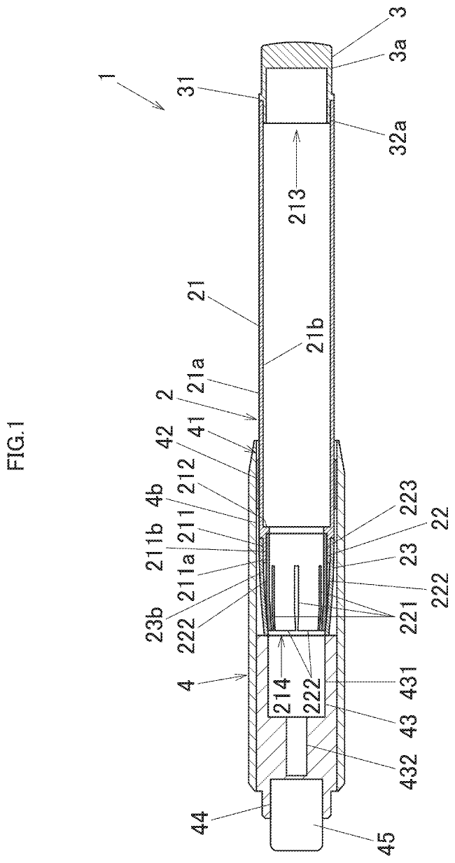

Hereinafter, a plurality of embodiments will be described with reference to the drawings. A writing instrument holder 1 according to the present embodiment illustrated in FIG. 1 is capable of internally housing a writing instrument such as a pencil, a width of a rear end part of which is larger than a width of a shaft thereof, and is capable of chucking the writing instrument so as to cause the writing instrument to protrude from a front end opening 214 of the writing instrument holder 1 by an arbitrary length. In the following description, a side of the front end opening 214 of the writing instrument holder 1 illustrated in FIG. 1 will be referred to as front and a side of a rear end opening 213 of the writing instrument holder 1 will be referred to as rear in a longitudinal direction (hereinafter, referred to as an axial direction when appropriate) of the writing instrument holder 1.

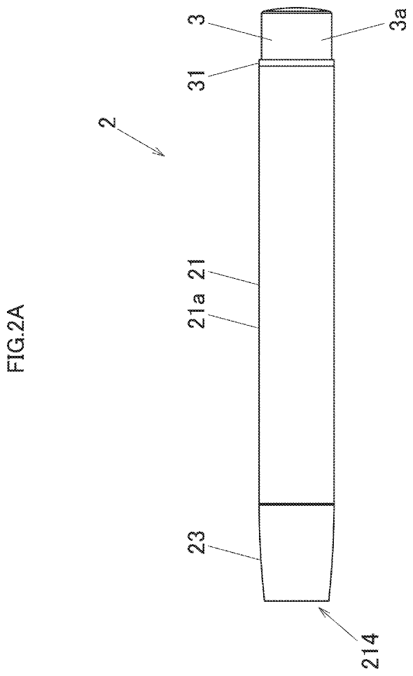

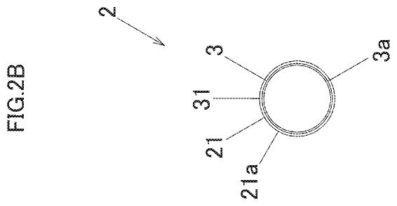

The writing instrument holder 1 includes a barrel 2, a top crown 3, and a cap 4. The barrel 2 is entirely formed in an approximately tubular shape (refer to the side view illustrated in FIG. 2A and the rear end surface diagram illustrated in FIG. 2B). The barrel 2 has a barrel main body 21, and a chuck 22 and a front fitting 23 assembled to a front end of the barrel main body 21. As will be described in detail later, in the present embodiment, a tip part of the chuck 22 pressed toward an inner side in a radial direction by the front fitting 23 clamps and chucks a writing instrument 5.

The barrel main body 21 is formed in an approximately tubular shape. The barrel main body 21 has a front end part 211 for assembling the chuck 22 and the front fitting 23 to the front end of the barrel main body 21. An outer diameter of an outer circumferential surface 211a of the front end part 211 is formed smaller than an outer diameter of the outer circumferential surface 21a of another portion of the barrel main body 21. An external screw that screws with an internal screw of the front fitting 23 to be described in detail later is formed on the outer circumferential surface 211a of the front end part 211.

A locking projection 212 is formed on an inner circumferential surface of the barrel main body 21 between an inner circumferential surface 211b of the front end part 211 and an inner circumferential surface 21b of the other portion. The locking projection 212 is arranged in a front part of the barrel main body 21 and is formed so as to annularly protrude inward in a radial direction from the inner circumferential surfaces 21b and 211b. The inner circumferential surface 211b of the front end part 211 is formed to the front of the locking projection 212. An inner diameter of the inner circumferential surface 211b of the front end part 211 is formed smaller than an inner diameter of the inner circumferential surface 21b that is another inner diameter part formed to the rear of the locking projection 212 that is one inner diameter part. The inner diameter of the inner circumferential surface 21b arranged to the rear of the locking projection 212 of the barrel main body 21 is formed larger than a width of a rear end part of the writing instrument 5 as will be described in detail later. The inner diameter of the inner circumferential surface 211b of the front end part 211 of the barrel main body 21 is formed larger than a width of a shaft 51 of the writing instrument 5 and smaller than a width of the rear end part of the writing instrument 5.

The chuck 22 is assembled to the inner circumferential surface 211b of the front end part 211 of the barrel main body 21. The chuck 22 is formed in an approximately tubular shape. The chuck 22 can be formed of a resin such as polyacetal or a metal such as brass. The chuck 22 is assembled with respect to the barrel main body 21 by press-fitting (inserting with pressure,) an outer circumferential surface of a base end part 223 formed at a rear end of the chuck 22 into the inner circumferential surface 211b of the front end part 211 of the barrel main body 21.

A plurality of notches 221 extending in the axial direction is formed in a front part of the chuck 22. Due to the notches 221, a plurality of chucking plates (chucking pieces) 222 is formed in the front part of the chuck 22. The chucking plate 222 is supported in a cantilevered manner by the base end part 223 and is formed so as to be elastically deformable toward an inner side in the radial direction. The chuck 22 is configured so that, when the chucking plate 222 elastically deforms toward the inner side in the radial direction, the chuck 22 can clamp and chuck the writing instrument 5 and, when the chucking plate 222 is restored toward an outer side in the radial direction, the chuck 22 can release the chuck on the writing instrument 5.

The front fitting 23 is attached to the front end part of the barrel main body 21. The front fitting 23 is formed in a tapered tubular shape that gradually tapers toward a front end thereof. An internal screw is formed at a rear end part of an inner circumferential surface 23b of the front fitting 23. The front fitting 23 is attached to the barrel main body 21 as the internal screw of the front fitting 23 screws with the external screw of the outer circumferential surface 211a of the front end part 211 of the barrel main body 21. When the front fitting 23 is attached to the front end part 211 of the barrel main body 21, a tapered front end of the inner circumferential surface 23b of the front fitting 23 abuts with an outer circumferential surface of the chucking plate 222 of the chuck 22 and presses and causes the chucking plate 222 to elastically deform toward an inner side in the radial direction of the barrel main body 21.

A rear end opening 213 with an approximately circular shape is formed in a rear end part of the barrel main body 21. The rear end opening 213 can be blocked by the top crown 3. The top crown 3 is formed in an approximately tubular shape having a blocking plate at a rear end thereof. An annular flange 31 that protrudes outward in the radial direction is formed on an outer circumferential surface in a front part of the top crown 3. An outer diameter of an outer circumferential surface 32a arranged to the front of the flange 31 is formed smaller than an outer diameter of an outer circumferential surface 3a arranged to the rear of the flange 31.

An external screw is formed on the outer circumferential surface 32a in the front part of the top crown 3. The top crown 3 is attached to the barrel main body 21 while blocking the rear end opening 213 of the barrel main body 21 as the external screw of the top crown 3 screws with an internal screw formed on the inner circumferential surface 21b of the barrel main body 21.

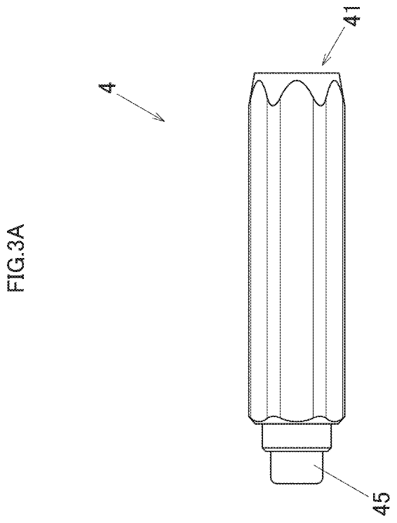

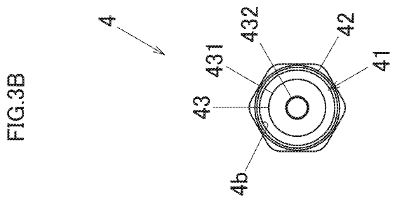

The cap 4 of the writing instrument holder 1 will be described with reference to FIGS. 3A and 3B. FIG. 3A illustrates a side view of the cap 4 and FIG. 3B illustrates a rear end surface diagram of the cap 4. The cap 4 is formed in an approximately tubular shape having a blocking plate at a tip thereof. The cap 4 according to the present embodiment is formed so as to have an approximately hexagonal outer circumferential shape which offers excellent design and which is capable of preventing rolling in the circumferential direction.

A tubular spring 42 is attached to an inner circumferential surface 4b in a vicinity of an opening part 41 of the cap 4. The tubular spring 42 has a plurality of leaf spring pieces (not illustrated) which extends in the axial direction and which is curved so as protrude inward in the radial direction. When the cap 4 is assembled to the front end part or the rear end part of the barrel main body 21, the plurality of leaf spring pieces presses the outer circumferential surface of the barrel main body 21 inward in the radial direction and holds the cap 4 on the outer circumferential surface of the barrel main body 21. The cap 4 can be detachably assembled to the front end part or the rear end part of the barrel main body 21.

A housing space 43 for housing a tip of the writing instrument 5 is formed inside the cap 4. The housing space 43 has a relatively large rear space 431 and a relatively small front space 432. Both the rear space 431 and the front space 432 are formed as an internal space with an approximately columnar shape. Both central axes of the front space 432 and the rear space 431 are arranged so as to coincide with a central axis of the cap 4 in the longitudinal direction (refer to FIG. 3B).

The blocking plate at the front end of the cap 4 has a circular recess 44 which opens forward. An eraser 45 is assembled to the recess 44.

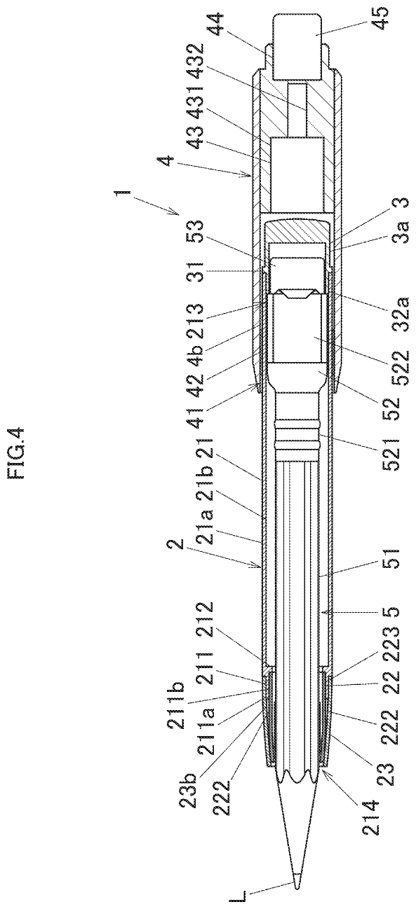

A state where the writing instrument 5 is chucked by the writing instrument holder 1 will now be described with reference to FIG. 4. The writing instrument 5 can be chucked by the writing instrument holder 1 by adjusting a relative position of the writing instrument 5 with respect to the writing instrument holder 1 so that a writing lead for a writing instrument L of the writing instrument 5 protrudes from the front end opening 214 of the writing instrument holder 1 by a prescribed amount. In doing so, the cap 4 can be attached to the rear end part of the barrel 2.

In the present embodiment, a case where a pencil is used as the writing instrument 5 will be exemplified. Moreover, in another embodiment, the writing instrument may be an arbitrary writing instrument such as a mechanical pencil. The writing instrument 5 has the writing lead for a writing instrument L at a front end and an eraser ferrule 52 at a rear end of the shaft 51. The eraser ferrule 52 has, at a front end thereof, a connecting part 521 which connects with the rear end of the shaft 51. The eraser ferrule 52 has, at a rear end thereof, an eraser holding part 522 which opens rearward. The eraser holding part 522 is formed in an approximately rectangular tubular shape. An eraser 53 is detachably attached into the eraser holding part 522.

The writing instrument 5 is formed so that a width of a rear end part to which is connected the eraser ferrule 52 is larger than a width of the shaft 51. The front end opening 214 of the barrel main body 21 is formed so as to enable the front end part and the shaft 51 of the writing instrument 5 to pass through, and the rear end opening 213 of the barrel main body 21 is formed so as to enable the shaft 51 and the rear end part (the eraser ferrule 52) of the writing instrument 5 to pass through. By removing the top crown 3 from the barrel main body 21 and inserting the writing instrument 5 into the barrel main body 21 from the rear of the rear end opening 213 of the barrel main body 21, the front end part and the shaft 51 of the writing instrument 5 pass through the front end opening 214 of the barrel main body 21 and, at the same time, the shaft 51 and the rear end part of the writing instrument 5 pass through the rear end opening 213 of the barrel main body 21. By causing a rear surface of the locking projection 212 of the barrel main body 21 and a front surface of a large-width part of the eraser ferrule 52 to abut with one another, relative forward movement of the writing instrument 5 with respect to the barrel main body 21 is restricted. Therefore, the writing instrument 5 does not become detached from the front of the barrel main body 21. In addition, once the top crown 3 is screwed to the rear end opening 213 of the barrel main body 21, the writing instrument 5 does not become detached from the rear of the barrel main body 21.

In a state where the front end part and the rear end part of the writing instrument 5 have respectively passed through the front end opening 214 and the rear end opening 213 of the barrel main body 21, at least a part of the writing instrument 5 is housed inside the barrel 2. When the front fitting 23 is fastened to the barrel main body 21 and the chuck 22 is elastically deformed toward an inner side in the radial direction by the tip of the front fitting 23, the chuck 22 clamps the writing instrument 5 and the shaft 51 of the writing instrument 5 can be chucked at an arbitrary position in the axial direction. Therefore, the writing instrument 5 can be used by adjusting a protruding length of the writing instrument 5 from the writing instrument holder 1 to an arbitrary length.

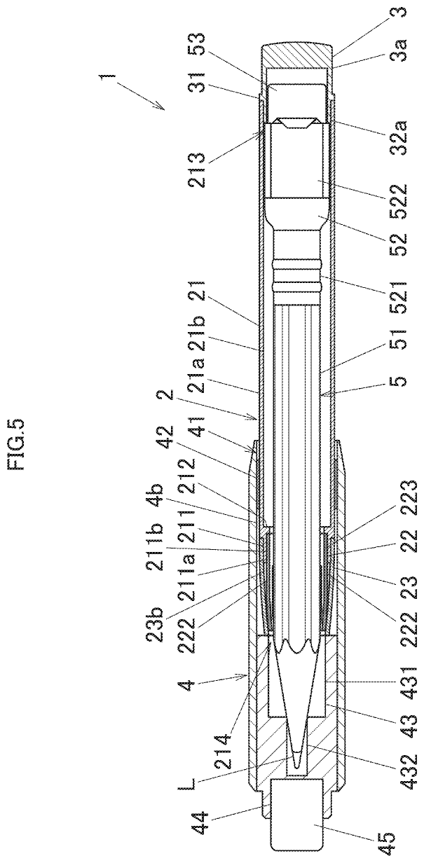

A state where the cap 4 is attached to the front end part of the barrel 2 and the writing lead for a writing instrument L at the tip of the writing instrument 5 is housed inside the writing instrument holder 1 will be described with reference to FIG. 5. The front end part of the writing instrument 5 is housed in the rear space 431 and the front space 432 of the cap 4. The writing lead for a writing instrument L at the tip of the writing instrument 5 is protected by being arranged so as to abut with or being slightly separated from the front end of the front space 432.

The writing instrument holder 1 described above may be used in another embodiment as a writing instrument holder set in which a plurality of the writing instrument holders 1 each having a mutually different length of the barrel 2 is combined. In this case, a configuration may be adopted in which a length of the barrel 2 of one writing instrument holder 1 is made shorter than a length of the barrel 2 of another writing instrument holder 1.

By adopting such a configuration, one writing instrument holder 1 in which the length of the barrel 2 corresponds to the length of the writing instrument 5 can be selected and used from the writing instrument holder set. For example, when the writing instrument 5 is a pencil, a length thereof in the axial direction is reduced in according to an amount of use. For example, when the pencil is relatively long, one writing instrument holder 1 of which barrel 2 is relatively long may be selected and used at a desk and, when the pencil becomes relatively shorter, another writing instrument holder 1 of which barrel 2 is relatively short may be selected and the other writing instrument holder 1 housing a short pencil may be carried around to be used at an outside location and the like. Alternatively, in yet another embodiment, when a length of the pencil is relatively long, yet another writing instrument holder 1 of which barrel 2 is relatively short may be selected and used at a desk and, when the pencil becomes relatively shorter, yet another writing instrument holder 1 of which barrel 2 is relatively long may be used at a desk so as to supplement a length of a shirt pencil. In this case, the length of a shortened pencil can be supplemented by the writing instrument holder 1 and the length of the pencil can be constantly adjusted to a certain length.

While embodiments have been described above, it is to be understood that the present invention is not limited to the embodiments described above and can be implemented with a wide variety of modifications.

What is claimed is:

1. A writing instrument holder chucking a writing instrument, a width of a rear end part of which is larger than a width of a shaft thereof,
the writing instrument holder including:
a barrel that houses at least a part of the writing instrument; and
a chuck that chucks the writing instrument, wherein
the barrel has a front end opening, through which a front end part of the writing instrument can pass, and a rear end opening, through which a rear end part of the writing instrument can pass.

2. The writing instrument holder according to claim 1, wherein the barrel includes one inner diameter part which is larger than the width of the shaft of the writing instrument and which is smaller than the width of the rear end part of the writing instrument, and another inner diameter part which is larger than the width of the rear end part of the writing instrument.

3. The writing instrument holder according to claim 1, further including a top crown that blocks the rear end opening of the barrel.

4. The writing instrument holder according to claim 2, further including a top crown that blocks the rear end opening of the barrel.

5. The writing instrument holder according to claim 1, further including a cap that is attachable to and detachable from a front end part or rear end part of the barrel.

6. The writing instrument holder according to claim 2, further including a cap that is attachable to and detachable from a front end part or rear end part of the barrel.

7. The writing instrument holder according to claim 3, further including a cap that is attachable to and detachable from a front end part or rear end part of the barrel.

8. The writing instrument holder according to claim 4, further including a cap that is attachable to and detachable from a front end part or rear end part of the barrel.

9. A writing instrument holder set in which a plurality of the writing instrument holders is combined according to claim 1, wherein a barrel of one writing instrument holder is configured so as to be shorter than a barrel of another writing instrument holder.

10. A writing instrument holder set in which a plurality of the writing instrument holders is combined according to claim 2, wherein a barrel of one writing instrument holder is configured so as to be shorter than a barrel of another writing instrument holder.

11. A writing instrument holder set in which a plurality of the writing instrument holders is combined according to claim 3, wherein a barrel of one writing instrument holder is configured so as to be shorter than a barrel of another writing instrument holder.

12. A writing instrument holder set in which a plurality of the writing instrument holders is combined according to claim 4, wherein a barrel of one writing instrument holder is configured so as to be shorter than a barrel of another writing instrument holder.

13. A writing instrument holder set in which a plurality of the writing instrument holders is combined according to claim 5, wherein a barrel of one writing instrument holder is configured so as to be shorter than a barrel of another writing instrument holder.

14. A writing instrument holder set in which a plurality of the writing instrument holders is combined according to claim 6, wherein a barrel of one writing instrument holder is configured so as to be shorter than a barrel of another writing instrument holder.

15. A writing instrument holder set in which a plurality of the writing instrument holders is combined according to claim 7, wherein a barrel of one writing instrument holder is configured so as to be shorter than a barrel of another writing instrument holder.

16. A writing instrument holder set in which a plurality of the writing instrument holders is combined according to claim 8, wherein a barrel of one writing instrument holder is configured so as to be shorter than a barrel of another writing instrument holder.
